(19) United States
(12) Patent Application Publication
(10) Pub. No.: US 2010/0061527 A1
(43) Pub. Date: Mar. 11, 2010

(54) Telephone grid

(76) Inventor: Kenneth Mason Wachtell, Jersey City, NJ (US)

Correspondence Address: Kenneth M. Wachtell, 45 River Drive So. #601, Jersey City, NJ, 07310, US

(21) Appl. No.: 12/214,922

(22) Filed: Sep. 10, 2008

(51) Int. Cl. H04M 11/00

(52) U.S. Cl. 379/52

(57) ABSTRACT

The nature of the disclosures of the Telephone Grid is a new process of jotting down telephone numbers. It is a process of checking off numbers on a grid, instead of having to write them down. It is especially useful to people who cannot write quickly, like the elderly or handicapped, as well as useful to business people who need to read and record numbers accurately.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING COMPACT DISC APPENDIX

Not Applicable.

### BACKGROUND OF THE INVENTION

The background of this invention stems from the problem of recording telephone numbers clearly and rapidly that one may hear during a phone conversation. This problem is especially acute for the elderly and for people with arthritis and other disabilities, who may have trouble writing down telephone numbers that they hear on the telephone or on message machines, which don't give them enough time to write numbers clearly and accurately.

### BRIEF SUMMARY OF THE INVENTION

The Telephone Grid solves the problem of recording telephone numbers clearly and rapidly by providing a checkoff system for each digit, which can be used with minimal hand motion, instead of having to write out each digit. This will solve the problems of the elderly and handicapped who have trouble or pain when writing and have to record a telephone number quickly.

### DETAILED DESCRIPTION OF THE INVENTION

The Telephone Grid is used as follows:

Supposing someone gets a phone call and during the call it becomes necessary to jot down a telephone number. Instead of writing it in the conventional way, the person would check off or put a line through that number as it appeared in each column of the telephone grid numbered 1, 2, 3, 4, 5, 6, 7, 8, 9, 0. Thus, for example, if the telephone number a person wanted to write down was 202-761-8932, the person would select the number “2” from the first column, “0” from the second column, “2” from the third column, and so on. [Sample A below] As more of a convenience, if the numbers are repeated as in the phone number 202-761-3300, the person could make a single line going through both digits, which would make it even easier [Sample B below]. The telephone number 202-761-9000 would be another example [Sample C below].

This would make recording telephone numbers faster and neater, and, for people with arthritis and other writing disabilities, less painful.

Sample A

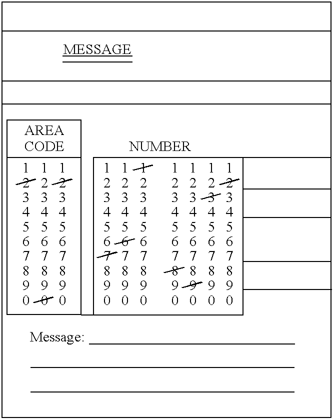

Sample B

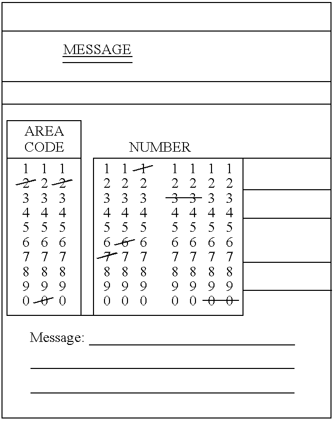

Sample C

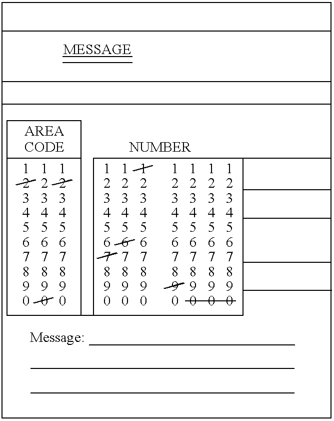

1. The claim of this invention is the process of using the Telephone Grid to record telephone numbers, making the task of jotting down a phone number easier, quicker and clearer and by making the task less painful by using less hand motion than the conventional method of recording telephone numbers. The telephone grid could be incorporated into a standard message pad format or used on its own.
